(19) United States
(12) Patent Application Publication
(10) Pub. No.: US 2016/0276664 A1
(43) Pub. Date: Sep. 22, 2016

(54) POSITIVE ELECTRODE ACTIVE MATERIAL FOR LITHIUM ION SECONDARY BATTERIES, METHOD FOR PRODUCING SAME AND LITHIUM ION SECONDARY BATTERY

(71) Applicant: HITACHI METALS, LTD., Minato-ku, Tokyo (JP)

(72) Inventors: Akira GUNJI, Tokyo (JP); Sho FURUTSUKI, Tokyo (JP); Shin TAKAHASHI, Tokyo (JP); Takashi NAKABAYASHI, Tokyo (JP); Shuichi TAKANO, Tokyo (JP); Hisato TOKORO, Tokyo (JP)

(73) Assignee: HITACHI METALS, LTD., Tokyo (JP)

(21) Appl. No.: 15/028,333

(22) PCT Filed: Feb. 13, 2015
(86) PCT No.: PCT/JP2015/053968

§ 371 Date: Apr. 8, 2016

(30) Foreign Application Priority Data
Mar. 31, 2014 (JP) 2014-073699

(51) Int. Cl. H01M 4/505; H01M 4/36; H01M 4/525; H01M 4/1391; H01M 4/62; H01M 10/0568; H01M 4/04; H01M 4/38; H01M 2/16; H01M 10/0525; H01M 10/0569; H01M 4/131; H01M 4/66

(52) U.S. Cl. CPC H01M 4/505; H01M 4/131; H01M 4/366; H01M 4/525; H01M 4/1391; H01M 4/625; H01M 4/661; H01M 4/0404; H01M 4/0471; H01M 4/0433; H01M 4/382; H01M 2/1653; H01M 2/162; H01M 10/0525; H01M 10/0569; H01M 10/0568; H01M 2004/028

(57) ABSTRACT

An object of the present invention is to provide lithium ion secondary batteries having cycle characteristics as well as high energy density and rate characteristics during high-potential charging of a layered compound. The following is provided, a positive electrode active material for lithium ion secondary batteries, comprising particles each having: a core part comprising a lithium metal composite oxide; and a surface layer part comprising a lithium metal composite oxide having a composition differing from that in the core part, the surface layer part being formed on the surface of the core part, wherein both the core part and the surface layer part have a layered structure, the surface layer part contains Ni, Mn, and Li, and Ni/Mn mole ratio in the surface is less than 1.

### TECHNICAL FIELD

The present invention relates to a positive electrode active material for lithium ion secondary batteries, which stores and releases lithium ions, a method for producing the same, and a lithium ion secondary battery.

### BACKGROUND ART

In recent years, based on the prevention of global warming and concern over the exhaustion of fossil fuels, an electric automobile requiring a low amount of energy for travel and a power generation system utilizing natural energy such as sunlight or wind are increasingly expected. However, such technologies have the following technological problems, and have not yet become popular.

A problem with electric automobiles is that the energy density of the driving battery is low and the travel distance possible with a single charge is short. Meanwhile, a problem with a power generation system utilizing natural energy is that power generation capacity fluctuates significantly, and thus a large capacity battery is necessary for constant output, resulting in high cost. Consequently, a secondary battery that has a low price and a high energy density is desired, regardless of the type of relevant technology.

A lithium-ion secondary battery has higher energy density per weight than a secondary battery such as a nickel hydrogen battery or a lead battery. Consequently, the application of a lithium-ion secondary battery to an electric automobile and an electric power storage system are expected. In order to respond to the needs of an electric automobile or an electric power storage system, however, an even higher energy density is required. In order to materialize higher energy density for a battery, it is necessary to increase the energy densities of the positive and negative electrodes.

A material having a layered structure represented by the composition formula LiMO₂ (layered-compound-type positive electrode active material) has been widely used as a positive electrode active material. A layered compound in which M is a metal element containing at least Ni or Co has excellent rate characteristics, and the theoretical capacity thereof is about 270 to 280 Ah/kg, but this varies depending on the composition of M. In practice, however, the capacity that can be reversibly used is only about 140 to 180 Ah/kg. This is because the charge potential can be increased only up to about 4.3 to 4.45 V with respect to the positive electrode potential of lithium metal (Hereinafter, the word “potential” refers to the lithium metal potential.). Higher potential charging allows higher capacity to be used. However, charging up to a high potential promotes electrolytic solution decomposition and causes crystal structure destruction, which results in reduction of positive electrode capacity with cycles. In order to solve this problem, surface treatment technology has been discussed.

Patent Literature 1 discloses a method for producing a positive electrode, comprising a step of obtaining a positive electrode active material by coating the surface of a cobalt-based lithium composite oxide with lithium nickel cobalt manganese via dry mixing with the addition of shear force. With this method, stability of a cobalt-based lithium composite oxide at high potentials can be improved.

In addition, it is known that a Li-rich material having a layered structure, which is represented by Li₁₊ₓM′₁₋ₓO₂ (where x>0.1, M′ contains Mn and Ni, and Mn>Ni) can achieve a high capacity not less than 250 Ah/kg when being charged at a potential of not less than 4.5 V (e.g., Patent Literature 2).

### CITATION LIST

### Patent Literature

Patent Literature 1: JP Patent Publication (Kokai) No. 2008-198465 A
Patent Literature 2: WO2011/021686

### SUMMARY OF INVENTION

### Technical Problem

In the case of the positive electrode material disclosed in Patent Literature 1, a cobalt-based lithium composite oxide is coated with a lithium transition metal oxide represented by the composition formula LiMO₂. As a lithium transition metal oxide with a low Mn content is used for a coating layer, the coating layer itself deteriorates at high potentials exceeding 4.5V. In addition, in the case of Patent Literature 1, a grain boundary is formed between a cobalt-based lithium composite oxide of a core and a coating layer on a surface, which prevents ionic diffusion and causes deterioration of rate characteristics.

Further, a Li-rich material having a layered structure reported in Patent Literature 2, etc. is inferior to a lithium transition metal oxide represented by the composition formula LiMO₂ in terms of reaction potential and rate characteristics.

An object of the present invention is to provide a positive electrode active material for lithium ion secondary batteries having cycle characteristics as well as high energy density and rate characteristics during high-potential charging of a layered compound, a method for producing the same, and a lithium ion secondary battery using the same.

### Solution to Problem

In order to achieve the above object, the positive electrode active material for lithium ion secondary batteries of the present invention is characterized in that: it comprises particles each having a core part comprising a lithium metal composite oxide and a surface layer part comprising a lithium metal composite oxide having a composition differing from that in the core part, the surface layer part being formed on the surface of the core part; both the core part and the surface layer part have a layered structure; the surface layer part contains Ni, Mn, and Li; and Ni/Mn mole ratio in the surface is less than 1 and preferably less than 0.95. It also may be secondary particles, wherein a plurality of such particles as primary particles are aggregated and bound. Preferably, at least the surface layer part of each secondary particle contains such particles.

In addition, in order to achieve the object, the method for producing a positive electrode active material for lithium ion secondary batteries of the present invention comprises: a mixing step of obtaining a mixture by mixing inner material particles represented by the composition formula Li₁₊ₓMO_{2+β} (where M is a metal element containing at least Ni or Co, −0.05<x<0.1, and −0.1<β<0.1) and outer material particles that are finer than the inner material particles and contain Ni, Mn, and Li with Ni/Mn mole ratio of less than 1; and a heating step of heating the mixture.

Moreover, in order to achieve the above object, the lithium ion secondary battery of the present invention is characterized in that it comprises the positive electrode active material described above.

This specification includes part or all of the contents as disclosed in the specification and/or drawings of Japanese Patent Application No. 2014-073699, which is a priority document of the present application.

### Advantageous Effects of Invention

According to the present invention, it is possible to provide a lithium ion secondary battery having cycle characteristics as well as high energy density and high rate characteristics.

Objects, configurations, and effects other than the above can be clearly understood based on the embodiments described below.

### BRIEF DESCRIPTION OF DRAWINGS

FIG. 1 shows a schematic view of the positive electrode active material in the Examples below.

FIG. 2 illustrates a crystal structure destruction mechanism in a layered compound during charging.

FIG. 3-1 illustrates a crystal stabilization mechanism in a Li-rich material during charging.

FIG. 3-2 schematically shows a crystal structure of a layered compound coated with a Li-rich material.

FIG. 3-3 shows schematic views of positive electrode active materials in the Examples.

FIG. 4 shows a vehicle using lithium ion batteries comprising a positive electrode active material in the Examples.

FIG. 5 shows an electric power storage system using a lithium ion battery comprising a positive electrode active material in the Examples.

FIG. 6 shows a TEM image of the positive electrode active material in the Examples.

### DESCRIPTION OF EMBODIMENTS

Hereinafter, the present invention is described in greater detail. Note that the embodiments below are merely examples, and thus the present invention is not limited thereto.

A lithium ion secondary battery used herein may be a lithium ion secondary battery having any form of conventional basic configuration, such as a cylindrical, flat, square, coin-shaped, button-shaped, or sheet form. For example, a lithium ion secondary battery can be configured to have a positive electrode, a negative electrode, and a separator that is sandwiched between the positive electrode and the negative electrode and immersed in an organic electrolyte. Note that a separator separates the positive electrode from the negative electrode to prevent short circuiting and has ion conductivity that allows lithium ions (Li⁺) to pass therethrough. Further, the positive electrode is composed of a positive electrode active material, an electrical conducting material, a binder, a current collecting material, and the like.

### 1. Primary Particles of Positive Electrode Active Material

Primary particles of a positive electrode active material are particles each having a core part and a surface layer part formed on the core part. A surface and an inner part have different compositions. Both the surface and the inner part have a layered structure. The surface contains Ni, Mn, and Li so that Ni/Mn mole ratio is less than 1 (the Ni content is less than the Mn content) in at least the composition of the outermost part of each primary particle. The core part comprises a lithium metal composite oxide having a layered structure. The surface layer part has a layered structure, contains Ni, Mn, and Li, and comprises a lithium metal composite oxide having a composition differing from that in the core part.

The term “layered structure” used herein means a layered crystal structure. The crystal structure can be confirmed with, for example, a transmission electron microscope image (TEM image).

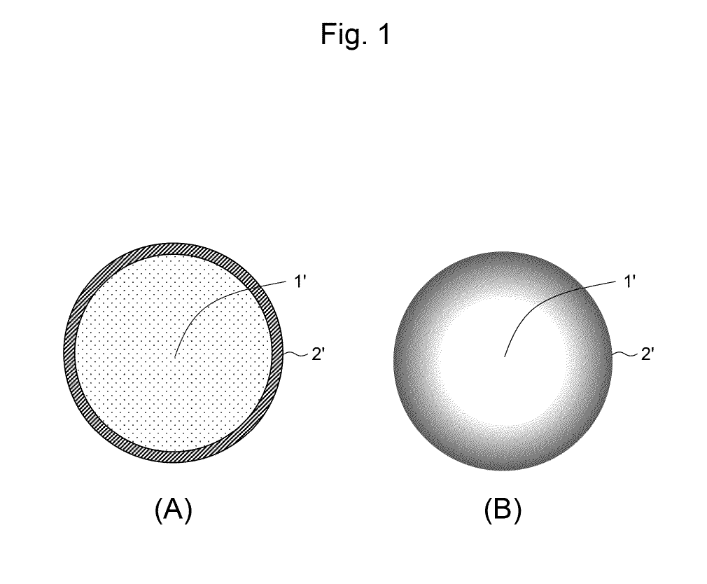

FIG. 1 (A) shows a schematic view of a primary particle of a positive electrode active material. In the primary particle of the positive electrode active material, a surface of a layered compound 1 of the core part is coated with an outer material 2. The outer material is a material which has a layered structure, contains Ni and Mn, and has Ni/Mn mole ratio of less than 1. More preferably, the mole fraction of Li to the total mole fraction of the other metal elements is greater than 1. When the outer material has the Ni/Mn mole ratio of less than 1 and the mole fraction of Li to the total mole fraction of the other metal elements of greater than 1, catalyst activity on the surface can be reduced, and electrolytic solution decomposition can be inhibited. Further, such stable outer material can prevent oxygen from being released on the surface of the layered compound, and crystal structure destruction can be inhibited. Note that as Li is also deintercalated from the outer material during charging, the mole fraction of Li to the total mole fraction of the other metal elements after charging is not necessarily greater than 1.

It is desirable for primary particles of a positive electrode active material to have a continuous layered crystal structure (integrated crystal structure) extending from the surface to the core part, in which a solid solution of the core part and the surface layer part is formed. The term “solid solution” used herein refers to a state in which components of compounds having different compositions diffuse each other to result in the formation of a continuous and integrated crystal structure.

It is also desirable for primary particles of a positive electrode active material that a solid solution is formed with an outer material 2′ on the surface of a layered compound 1′ of the core part in an interface region between the surface layer part and the core part (FIG. 1(B)). It is further desirable that a continuous crystal structure (integrated crystal structure) is formed between the surface layer part and the core part. Accordingly, diffusion of Li ions is not prevented and the effect of preventing oxygen from being released from the layered compound surface is enhanced. The continuous crystal structure ranging from the surface to the core part can be confirmed based on, for example, a transmission electron microscope image (TEM image).

Ni/Mn mole ratio in the surface of a primary particle of a positive electrode active material is less than 1 and preferably less than 0.95. When the Ni/Mn mole ratio is less than 1, it is likely to prevent electrolytic solution decomposition at high potentials and crystal structure destruction during high-potential charging, which results in the improvement of cycle characteristics during high-potential charging of the layered compound of the core part of a positive electrode active material. Further, when a Li-rich material is used for the outer material of a positive electrode active material, it can serve as active material, thereby preventing capacity and rate characteristics from declining so that they can be maintained together with cycle characteristics.

The mole fractions of Ni, Mn, and Li in the surface layer part of a primary particle of a positive electrode active material can be determined in accordance with required properties. The mole fractions of Ni, Mn, and Li in the surface of a primary particle of a positive electrode active material is, for example, Ni:Mn:Li=0 to 45:30 to 80:105 to 133 and preferably Ni:Mn:Li=1 to 45:35 to 75:105 to 133.

The surface layer part of a primary particle of a positive electrode active material may further contain other elements as well as Ni, Mn, and Li in order to adjust physical properties and the like. Examples of such other elements include, but are not particularly limited to, a variety of elements such as Co, Al, V, Fe, Mo, Zr, Ti, W, Cr, Mg, Nb, Cu, Zn, Sn, Si, P, and F. A preferable example is Co. Two or more of these elements (A) may be contained.

When the surface layer part of a primary particle of positive electrode active material contains Co as well as Ni, Mn, and Li, the mole fractions of Ni, Co, and Mn in the surface is, for example, Ni:Co:Mn=0 to 45:0 to 30:30 to 80, preferably Ni:Co:Mn=5 to 45:1 to 30:40 to 75, and particularly preferably Ni:Co:Mn=15 to 40:1 to 15:50 to 70.

Preferably, the surface layer part of a primary particle of a positive electrode active material is composed of a so-called “Li-rich material” which can be represented by the composition formula Li₁₊ₐNi_{b}Mn_{c}A_{d}O_{2+α} (where A is an element other than Li, Ni, and Mn, 0.05≦a<0.33, 0<b<0.45, 0.30≦c<0.75, b/c<1, 0≦d<0.3, a+b+c+d=1, −0.1<α<0.1, and α is a value that appropriately varies in accordance with the mole fraction of Li and type and valence of the metal element and the like), and has the mole fraction of Li to the total mole fraction of Ni, Mn, and the element A of greater than 1.

The fraction (b) of Ni tends to increase because of the diffusion of components of the inner material of the inside. However, in order to maintain the mole fraction of Mn in the surface layer part to improve lifetime, it is preferable to decrease the fraction (b) of Ni. The sufficient total fraction of Co and Ni is about 0.2 in order to maintain the structure of the surface layer part. It is preferable to increase the fraction (c) of Mn in order to maintain an excessive amount of Li in the surface so as to contribute to the improvement of stability at high potentials. Meanwhile, if the fraction (c) is excessively increased, it causes decreased activity, which is undesirable. The fraction (d) of the other element A can be set to a value that allows securement of the amounts of Ni and Mn and adjustment of other physical properties. In particular, if A includes Co, it is preferable to set “d” to 0 to less than 0.3, and if A includes a different element, it is preferable to set “d” to about 0 to 0.1. Given that the total mole fraction of other elements (Ni, Mn, and A) is 1, the mole fraction of Li should be 1.1 or more.

It is desirable for the surface layer part having a solid solution layer to be thinly and uniformly disposed on the surface of a layered compound of the core part. The thickness of the surface layer part is desirably 120 nm or less and more desirably 50 nm or less. In addition, it is desirable that the thickness of the surface layer part to the particle size of the layered compound of the core part is not more than 0.1 in a positive electrode active material.

The layered compound of the core part of a primary particle of a positive electrode active material is not particularly limited as long as it has a layered structure that allows lithium ions to be stored and released. Therefore, materials with different compositions can be used. The layered compound has excellent rate characteristics. In any case, crystal structure destruction can be prevented by providing the above surface layer part without preventing storage and release of lithium ions in the layered compound of the core part. Accordingly, cycle characteristics can be improved while maintaining rate characteristics.

Preferably, the layered compound of the core part of a primary particle of a positive electrode active material can be represented by the composition formula Li₁₊ₓMO_{2+β} (where M is a metal element containing at least Ni or Co, −0.05<x<0.1, and −0.1<β<0.1). It is preferable for the layered compound to have a hexagonal crystal structure of LiMO₂.

Examples of a metal element M in the above composition formula include, but are not particularly limited to, a variety of metal elements such as Ni, Mn, Co, Al, V, Fe, Mo, Zr, Ti, W, Cr, Mg, Nb, Cu, and Zn. However, in view of capacity and resistance, Ni, Mn, and Co are preferable. The layered compound of the core part of a primary particle of a positive electrode material may contain two or more of these metal elements M. In one embodiment, a metal element M includes at least Ni or Co. Also, in one embodiment of the present invention, metal elements M include Ni and Mn. If the layered compound of the core part of the positive electrode active material of the present invention contains Ni and Mn, Ni/Mn mole ratio of the core part is preferably 1 or more.

When a metal element M contained in the core part of the positive electrode active material of the present invention is Co, it is preferable for the mole fraction of Co in the surface layer part of the positive electrode active material to be less than that in the core part of the positive electrode active material.

The composition of the core part of a primary particle of a positive electrode active material can be represented by, for example, the composition formula Li₁₊ₓNiₚCo_{q}MnᵣO₂, Li₁₊ₓCoO₂, or Li₁₊ₓNiₚCo_{q}AlₛO₂ (where −0.05<x<0.1, p>r, p>0, q≧0, r≧0, and s≧0). Note that the condition 0.1<1+x<1.1 is valid after charging because of deintercalation of Li.

As described above, it is desirable for a primary particle of a positive electrode active material that a solid solution is formed with the outer material on the surface of the layered compound of the core part in an interface region between the surface layer part and the core part. It is preferable for primary particles of a positive electrode active material that the mole fractions of metal elements continuously vary from the surface layer part side to the core part side or vice versa of the positive electrode active material in a layer containing a solid solution formed with the outer material on the surface of the layered compound of the core part. This makes it possible to reduce the difference in the crystal lattice constant resulting from a difference in composition or a difference in expansion and compression caused by charge and discharge. The thickness of the solid solution layer in the interface region between the surface layer part and the core part varies depending on the compositions of the layered compound of the core part and the surface layer part. It is, however, for example, 5 to 120 nm and preferably 10 to 50 nm.

The state in which the mole fractions of metal elements continuously vary from the surface layer part side to the core part side or vice versa of the positive electrode active material in the interface region between the surface layer part and the core part of the positive electrode active material means that the mole fractions of metal elements continuously decrease or increase from the surface layer part side to the core part side or vice versa in the solid solution layer in the interface region between the surface layer part and the core part of the positive electrode active material. The mole fractions of metal elements may continuously decrease or increase with a substantially linear slope or they may gradually decrease or increase in two or more stages. A continuous shift in the mole fractions of metal elements can be confirmed by, for example, determining the mole fractions of metal elements of the positive electrode active material in the direction from the surface layer part side to the core part side or vice versa by TEM-EDX.

In one embodiment, the mole fraction of Mn continuously varies from the surface layer part side to the core part side of a positive electrode active material in the interface region between the surface layer part and the core part (hereinafter also simply referred to as “interface region”) of a primary particle of a positive electrode active material. The mole fraction of Mn decreases from the surface layer part side to the core part side of a primary particle of a positive electrode active material in the interface region. For example, the mole fraction of Mn decreases from the surface layer part side to the core part of a primary particle of a positive electrode active material in the interface region under conditions in which variations in the mole fraction of the metal element (%) relative to variations in the thickness direction (nm) (variations in the mole fraction of metal element (%)/variation in the thickness direction (nm)) are from 1% to 20%.

In one embodiment, the mole fraction of Ni continuously varies from the surface layer part side to the core part side of a positive electrode active material in the interface region between the surface layer part and the core part of a primary particle of a positive electrode active material. The mole fraction of Ni increases from the surface layer part side to the core part side of a primary particle of a positive electrode active material in the interface region. For example, the mole fraction of Ni increases from the surface layer part side to the core part of a primary particle of a positive electrode active material in the interface region under conditions in which variation in the mole fraction of the metal element (%) relative to variations in the thickness direction (nm) are from 1% to 20%.

In one embodiment, the mole fraction of Co continuously varies from the core part side to the surface layer part side of a positive electrode active material in the interface region between the surface layer part and the core part of a primary particle of a positive electrode active material. The mole fraction of Co decreases from the core part side to the surface layer part side of a primary particle of positive electrode active material in the interface region. For example, the mole fraction of Co decreases from the core part side to the surface layer part side of a primary particle of positive electrode active material in the interface region under conditions in which variations in the mole fraction of the metal element (%) relative to variations in the thickness direction (nm) are from 0.5% to 10%.

In one embodiment, Ni/Mn mole ratio continuously varies from the surface layer part side to the core part side of positive electrode active material in the interface region between the surface layer part and the core part of a primary particle of a positive electrode active material. Ni/Mn mole ratio increases from the surface layer part side to the core part side of a positive electrode active material in the interface region. For example, Ni/Mn mole ratio increases from the surface layer part side to the core part of a primary particle of a positive electrode active material in the interface region under conditions in which variations in the mole ratios of the metal elements relative to variations in the thickness direction (nm) are from 0.01 to 0.25.

Preferably, the mole fraction of Li in the surface layer part of a positive electrode active material is greater than that in the core part of the positive electrode active material.

In one embodiment, the mole fraction of Li continuously varies from the core part side to the surface layer part side of a positive electrode active material in the interface region between the surface layer part and the core part of a positive electrode active material. The mole fraction of Li increases from the core part side to the surface layer part side of a positive electrode active material in the interface region. For example, the mole fraction of Li increases from the core part side to the surface layer part side of positive electrode active material in the interface region under conditions in which variations in the mole fraction of the metal element (%) relative to variations in the thickness direction (nm) are from 0.001 to 0.01.

The average particle size of a primary particle of a positive electrode active material is, for example, 0.1 μm to 20 μm and preferably 0.5 μm to 15 μm. The particle size can be determined through observation using a scanning electron microscope or a transmission electron microscope or determined using a laser diffraction scattering particle size analyzer.

In addition, a positive electrode active material may be further coated with an electrochemically inactive material such as Al₂O₃, SiO₂, MgO, TiO₂, SnO₂, B₂O₃, Fe₂O₃, ZrO₂, AlF₃, or a carbon material. In such case, the term “surface” used herein refers to the surface under the electrochemically inactive coating material but not the uppermost surface of the positive electrode active material.

Principles based on which high cycle characteristics can be obtained with the use of a Li-rich material having Ni/Mn<1 as the outer material are described below. Note that the following description includes assumptions because of unknown matters. Therefore, even if there are errors in the principles explained below, they would not impair the effects of the present invention.

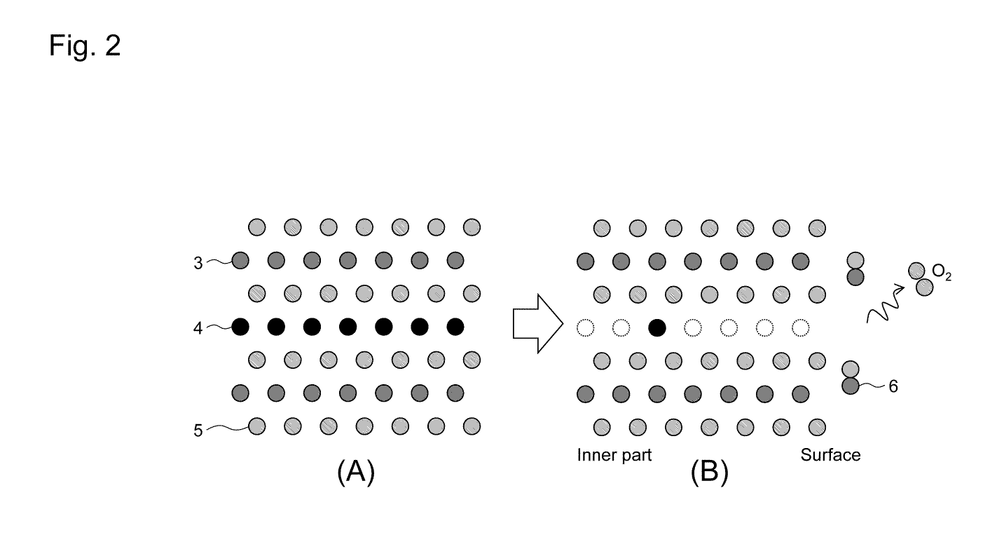

The layered compound containing Ni and/or Co mainly comprises metal elements such as Ni and/or Co having high catalyst activity. Therefore, the layered compound promotes electrolytic solution decomposition at high potentials. In addition, as shown in FIG. 2 (A), a transition metal M, lithium, and oxygen form a layered structure in a discharge state, which results in a stable crystal structure. However, as shown in FIG. 2 (B), a high-potential charge causes the greater part of an intracristalline Li layer to become vacant, resulting in destabilization of the crystal structure. This changes Ni or Co to a stable divalent or trivalent oxide. The reactions are outlined in formulae 1 and 2 below:

LiM^{(III)}O₂→Li⁺M^{(IV)}O₂+e⁻ (charge reaction) (Formula 1)

M^{(IV)}O₂→M^{(III)}O_{1.5}+0.25O₂→M^{(II)}O+0.5O₂ (decomposition reaction) (Formula 2)

Note that as oxygen needs to be released in the reaction of formula 2, the reaction takes place mainly on the active material surface.

In addition, it is difficult to stably synthesize a layered compound having the composition Ni<Mn, which is likely to result in a shift to a spinel structure. However, under Li-rich conditions, a crystal structure in which a transition metal layer contains Li as in the case of Li₂MnO₃ is formed, resulting in stable synthesis. The Li-rich material having Ni/Mn<1 has such crystal structure.

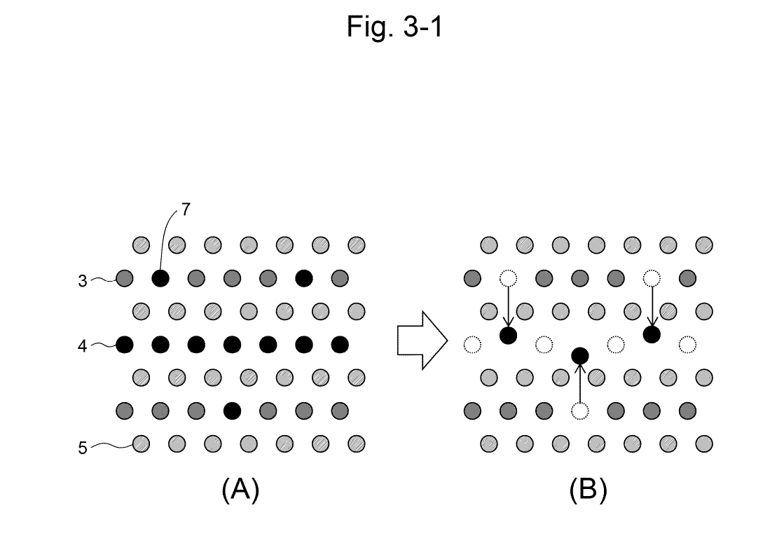

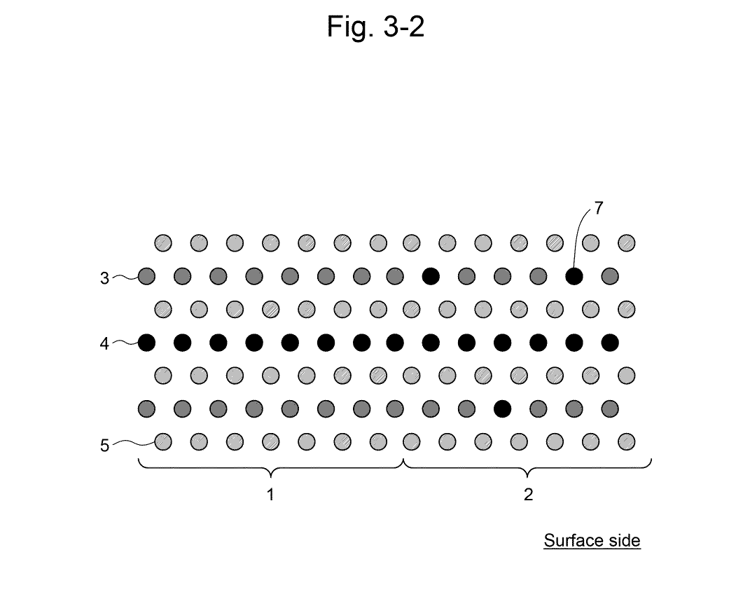

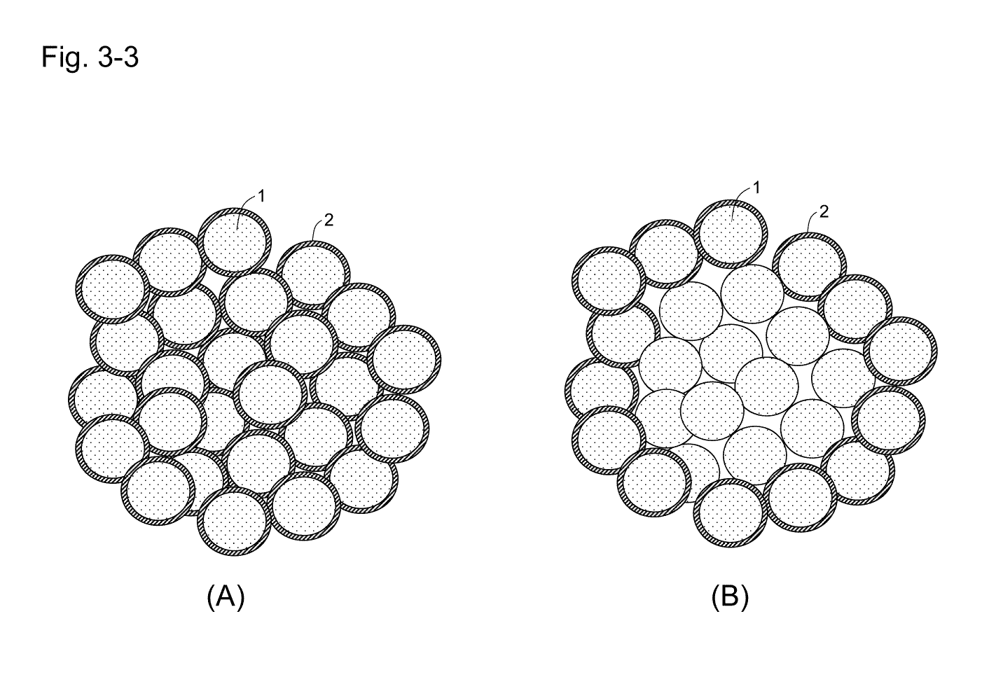

The Li-rich material having Ni/Mn<1 mainly comprises Mn, which has lower catalyst activity than Ni or Co. Therefore, electrolytic solution decomposition is unlikely to occur at high potentials. Further, as shown in FIG. 3-1 (A), the Li-rich material also contains Li in the transition metal layer. As shown in FIG. 3-1 (B), after lithium has been released from the lithium layer during charging, Li in the transition metal layer migrates to the Li layer during high-potential charging, which is unlikely to cause destabilization of the crystal structure, thereby preventing decomposition.

Therefore, as shown in FIG. 3-2, by coating the surface side of a layered compound 1 with a Li-rich material as an outer material 2, it is possible to prevent decomposition of an electrolytic solution or deterioration of a positive electrode active material at a high potential of 4.5V or greater. In addition, since both the layered compound and the outer material have a layered structure, a continuous crystal structure in which a Li layer, a transition metal layer, and an oxygen layer are integrated can be formed.

It is preferable for the surface layer part to have a thickness that allows the composition of the uppermost surface to be maintained at a level sufficient to prevent deterioration during high-potential charging. Meanwhile, if the surface layer part is excessively thick, battery properties such as capacity and output might be reduced. Therefore, it is preferable for the surface layer part to have a thickness of 120 nm or less. Note that when the solid solution layer described below is formed, the thickness of the surface layer part includes the thickness of the solid solution layer.

As stated above, the mole fraction of Li differs between the core part and the surface layer part. If a difference in the amount of Li or the metal component ratio is significant, stress might be generated in the interface region due to a difference in crystal lattice constant resulting from a difference in composition or a difference in expansion and compression caused by charge and discharge. Therefore, it is preferable to form a solid solution in the interface region, thereby causing components to continuously vary. An area in which a solid solution is formed may extend to an extent that allows reduction of the above stress. In addition, in order to increase the area where a solid solution is formed, it is necessary to increase the amount of an outer material that constitutes the surface layer part as well as the area in which the composition varies on the side of the layered compound that constitutes the core part. Therefore, in consideration of the interlayer distance in a crystal and metal element size, the sufficient thickness of the solid solution layer is 120 nm or less.

### 2. Method for Producing Primary Particles of Positive Electrode Active Material

A positive electrode active material can be produced by a method comprising a mixing step of obtaining a mixture by mixing inner material particles and outer material particles that are finer than the inner material particles and a heating step of heating the obtained mixture. A mixture in which the surface of each inner material particle is covered with an outer material can be obtained by mixing inner material particles and outer material particles.

The above-described layered compound for a positive electrode active material can be used as an inner material for a positive electrode active material.

Preferably, the inner material can be represented by the composition formula Li₁₊ₓMO_{2+β} (where M is a metal element containing at least Ni or Co, −0.05<x<0.1, and −0.1<β<0.1). Note that β may appropriately vary in accordance with the fraction of Li and the type and proportion of a metal element M. The metal element M comprises at least Ni or Co. The inner material can be expressed by, for example, the composition formula Li₁₊ₓNiₚCo_{q}MnᵣO₂, Li₁₊ₓCoO₂, Li₁₊ₓNiₚCo_{q}AlₛO₂ (where −0.05<x<0.1, p>r, p≧0, q≧0, r≧0, and s≧0).

The outer material used for a positive electrode active material is not particularly limited as long as it can constitute the above-described surface layer part of a positive electrode active material. As stated above, a solid solution is formed with the outer material on the layered compound of the inner material in the interface region between the surface layer part and the core part of a primary particle of a positive electrode active material. If the area in which a solid solution is formed extends to the uppermost surface of the outer material as a whole, the surface composition of the obtained positive electrode active material will differ from the composition of the outer material used.

A Li-rich material or a mixture of starting material compounds thereof may be used as the outer material. Preferably, the outer material is not particularly limited, and the examples of materials described above for the surface layer part of a positive electrode active material can be used. Preferably, the outer material can be represented by the composition formula Li₁₊ₐNi_{b}Mn_{c}A_{d}O_{2+α} (where A is an element other than Ni, Mn, and Li, 0.05<a<0.33, 0<b<0.40, 0.35≦c<0.80, b/c<1, 0≦d<0.3, a+b+c+d=1, and −0.1<α<0.1).

Heat treatment causes elements of the inner material to diffuse into the outer material. Accordingly, the composition of the surface layer part after heat treatment shifts from the composition of the outer material to the composition of the inner material. Therefore, in order to obtain a desirable composition for the surface layer part, an appropriate outer material composition can be determined. In addition to the above, a material having mole fractions of Li and Mn which are greater than those in the inner material can be used as the outer material. For example, it is possible to use a material containing Li and Mn without Ni, which is expressed by the composition formula Li₁₊ₓMn₁₋ₓO_{2+β} (where 0.25<x<0.4 and −0.1<β<0.1) and preferably Li₂MnO₃ (Li_{1.33}Mn_{0.67}O₂). Note that Li₂MnO₃ has low electron conductivity and tends to cause resistance, thus it does not remain as Li₂MnO₃ after heat treatment. Therefore, a Li-rich material containing the other metal elements and having a layered structure is desirable.

The weight ratio of the inner material to the outer material is, for example, 99:1 to 85:15, but it is not particularly limited thereto. In view of capacity and resistance, it is preferable to decrease the amount of the outer material. Meanwhile, in view of inhibition of a reaction with an electrolytic solution, it is necessary to use a sufficient amount of the outer material. Preferably, the weight ratio is 98:2 to 93:7.

The step of mixing the inner material and the outer material can be carried out using, for example, a mortar with a pestle, a ball mill, a jet mill, a rod mill, or a high shear blender.

In the heating step of performing heating treatment of a mixture of inner material particles and outer material particles, heating conditions are not particularly limited as long as a solid solution is formed with outer material particles on the surfaces of inner material particles. The conditions can be selected depending on inner material particles to be used. Regarding heating treatment, in order to form a solid solution so as to obtain an integrated crystal structure and maintain the diffusion distance within a certain range, the heat treatment temperature is, for example, 600° C. or more, desirably 600° C. to 1050° C., and further desirably 750° C. to 950° C.

In addition, the heat treatment temperature is desirably at or lower than the heat treatment temperature for production of inner material particles (synthesis temperature). If heat treatment is performed above the synthesis temperature, component diffusion proceeds excessively, which causes the composition of the surface layer part to shift to the composition of the core part. In addition, heat treatment time can be appropriately determined in accordance with the inner material and the outer material to be used and heat treatment temperature; however, it is desirably 30 minutes to 6 hours.

A positive electrode active material manufactured by the above method has the preferable effects described above.

In one preferable embodiment, the positive electrode active material can be produced by a step of allowing an outer material having a layered structure and containing Ni, Mn, and Li with Ni/Mn mole ratio of less than 1 to come into contact with the surface of an inner material that has layered structure and can be represented by the composition formula Li₁₊ₓMO_{2+β} (where M is a metal element containing at least Ni or Co, −0.05<x<0.1, and −0.1<β<0.1) so as to form a solid solution via heat treatment.

In one preferable embodiment described above, the outer material can be represented preferably by the composition formula Li₁₊ₐNi_{b}Mn_{c}A_{d}O_{2+α} where A is an element other than Li, Ni, and Mn, 0.05≦a<0.33, 0<b<0.40, 0.35≦c<0.80, b/c<1, 0≦d<0.3, a+b+c+d=1, and −0.1<α<0.1.

### 3. Positive Electrode Active Material Comprising Secondary Particles

The positive electrode active material may be in the form of secondary particles obtained by aggregating and binding a plurality of the above primary particles for the ease of handling. A secondary particle has a grain boundary therein and thus can be distinguished from a primary particle having no grain boundary therein.

FIG. 3-3 shows a cross section of a positive electrode active material comprising secondary particles. A plurality of the above primary particles are aggregated and bound to form a secondary particle. The use of a secondary particle for a positive electrode active material also contributes to the improvement of energy density of a positive electrode and the like.

In a positive electrode active material comprising a secondary particle, as shown in FIG. 3-3 (A), an each primary particle contained in the whole secondary particle may be a particle in which the surface of a layered compound 1 of the core part is coated with an outer material 2. Alternatively, as shown in FIG. 3-3 (B), primary particles disposed in at least the vicinity of the surface (outer portion) of a secondary particle may be a particle in which the surface of a layered compound 1 of the core part is coated with an outer material 2, while primary particles in the center portion thereof may be a layered compound 1 as such. As shown in FIG. 3-3 (A), when the particles coated with an outer material are used up to inner part of the secondary particle, it is possible to further prevent reduction of cycle characteristics so as to achieve a long lifetime. Further, as shown in FIG. 3-3 (B), even when the coated particles are used to only the particles in the vicinity of the surface of the secondary particle, it is possible to obtain the effect of improving cycle characteristics and it is also possible to provide a positive electrode active material having excellent rate characteristics.

As in the case of the positive electrode active material comprising primary particles described above, the particle sizes of primary particles can be adjusted in accordance with the composition and the like of the layered compound and production conditions. In general, the particle sizes are each about several hundred nanometers to 20 μm, e.g., about several micrometers to 20 μm. For instance, the particle sizes of layered compound particles mainly comprising Ni and Mn are up to about 3 μm. The particle sizes of layered compound particles mainly comprising Co tend to increase, and they can be set to about 15 to 20 μm. The particle sizes of secondary particles are preferably about 3 to 50 μm, although this depends on the particle sizes of primary particles. If only primary particles disposed in the vicinity of the surface of a secondary particle have a surface layer part, it is preferable that the primary particles present in 5% to 15% of the depth of the secondary particle size have the surface layer part.

Desirably, primary particles forming a secondary particle are of a positive electrode active material obtained by the above production method.

### 4. Method for Producing Secondary Particle

Further, a method for producing a secondary particle is described below. A secondary particle can be produced by aggregating and binding primary particles obtained by the above production method to form a secondary particle.

A secondary particle can be formed with primary particles by, for example, spray-drying a slurry of primary particles, followed by heat treatment. It is also possible to form a secondary particle during heat treatment of an inner material and an outer material by spray-drying of a slurry of a mixture of the inner material and the outer material, followed by heat treatment.

It is also possible to prepare a secondary particle formed with aggregated particles of an inner material and mix the secondary particle with an outer material, followed by heat treatment. The outer side of a secondary particle is likely to be in contact with outer material. Therefore, a secondary particle may have a thicker surface layer part on the outer side thereof and a thinner (or no) surface layer part on the inner side thereof.

### 5. Negative Electrode

Preferably, a negative electrode used for a lithium ion secondary battery has a low discharge potential. Examples of materials used for such negative electrode include various materials such as a lithium metal, carbon with a low discharge potential, Si, Sn and an alloy or oxide thereof with a large weight ratio capacity, and highly safe lithium titanate (Li₄Ti₅O₁₂).

### 6. Separator

A separator used for a lithium ion secondary battery may be prepared with an ion-conductive and insulating material, which is insoluble in an electrolytic solution, such as a porous material or non-woven fabric of PE or PP. Examples of an organic electrolytic solution that can be used include a solution obtained by dissolving a Li salt such as LiPF₆ or LiBF₄ in a cyclic carbonate such as EC or PC or a linear carbonate such as DMC, EMC, or DEC.

### 7. Lithium Ion Secondary Battery and the Use Thereof

A lithium ion secondary battery having a positive electrode comprising the positive electrode active material described above is explained. The effects of the present invention are significantly exhibited when a battery is charged to a high voltage. However, the voltage is not necessarily high, and any voltage charge can be selected.

A lithium ion secondary battery having a positive electrode comprising the above positive electrode active material can be used for a battery module. Thus, it can be applied to power sources of various vehicles such as a hybrid train that runs using an engine and a motor, an electric automobile that runs by a motor using a battery as an energy source, a hybrid automobile, a plug-in hybrid automobile having batteries that can be charged from the outside, and a fuel battery automobile that uses electric power generated in a chemical reaction between hydrogen and oxygen.

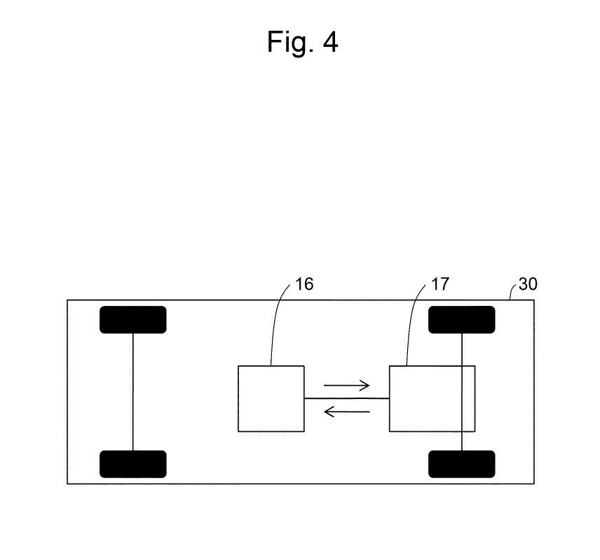

FIG. 4 shows a schematic plan view of an electric automobile (vehicle) driving system as a representative example.

Electric power is supplied from a battery module 16 to a motor 17 via a battery controller, a motor controller, and the like (not shown) so that an electric automobile 30 is driven. In addition, electric power regenerated by the motor 17 during deceleration is stored in the battery module 16 via the battery controller.

As shown in FIG. 4, by making use of a battery module 16 comprising at least one lithium ion secondary battery having a positive electrode of a positive electrode active material, the energy density and output density of the battery module are improved, which allows the travel distance of the system of an electric automobile (vehicle) 30 to be extended and the output to be improved.

In addition to the above examples, the lithium ion secondary battery can be applied to, but is not limited to, a wide range of vehicles such as forklifts, in-plant guided vehicles in factories and the like, powered wheelchairs, various satellites, rockets, and submarines, as long as the vehicles have batteries.

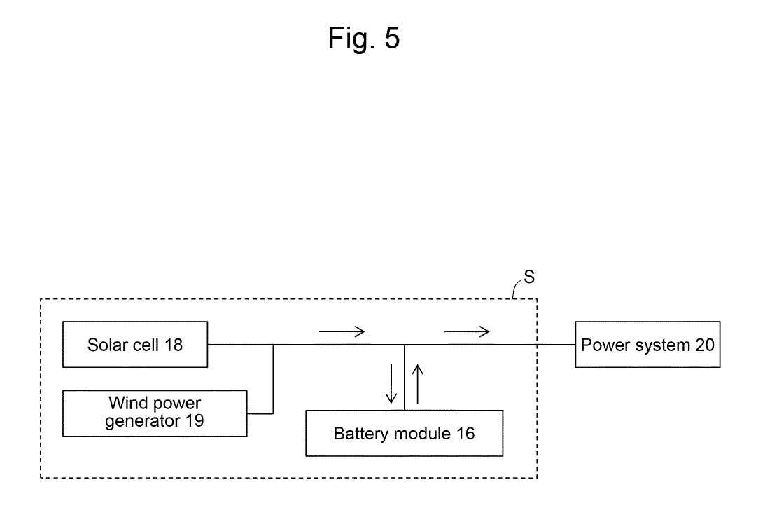

In addition, a battery module using at least one lithium ion secondary battery using a positive electrode comprising a positive electrode active material can be applied to electric power storage power sources of a power generation system (electric power storage system) S that utilizes natural energy such as a solar cell 18 that converts solar light energy to electric power and wind power generation which generates electric power by wind. FIG. 5 schematically shows such battery module.

In the cases of power generation with natural energy generated by a solar cell 18, a wind power generator 19, and the like, the amount of power generation is unstable. Therefore, for the purpose of stable power supply, it is necessary to charge and discharge electric power from an electric power storage power source in accordance with the load on the side of a power system 20.

By applying a battery module 16 having at least one lithium ion secondary battery using a positive electrode comprising a positive electrode active material to the above electric power storage power source, it is possible to obtain required capacity and output with a small number of batteries, thereby reducing the cost of the power generation system (electric power storage system) S.

Moreover, a power generation system using a solar cell 18 and a wind power generator 19 is exemplified above as an electric power storage system. However, the present invention is not limited thereto, and thus it can be applied to a wide range of electric power storage systems using other power generators.

### EXAMPLES

### Example 1

The Examples below are provided as embodiments to describe the present invention in detail. However, the technical scope of the present invention is not limited to such Examples.

### Synthesis of a Layered Compound NCM523

The term “NCM523” used herein refers to a layered compound represented by the composition formula Li₁₊ₓNi_{0.5}Co_{0.2}Mn_{0.3}O_{2+β} (where −0.05<x<0.1 and −0.1<β<0.1).

Lithium carbonate, nickel carbonate, cobalt carbonate, and manganese carbonate were weighed at a mole ratio of Li:Ni:Co:Mn=1.03:0.5:0.2:0.3, followed by pulverization and mixing using a planetary ball mill. The thus obtained powder mixture was baked at 950° C. for 12 hours in an air atmosphere to synthesize a layered active material (Li_{1.03}Ni_{0.5}Co_{0.2}Mn_{0.3}O₂). The average particle size (measured by a scanning electron microscope) of the obtained layered active material was 1 μm.

### Synthesis of Li-Rich Material (Li_{1.2}Ni_{0.2}Mn_{0.6}O₂)

Lithium carbonate, nickel carbonate, and manganese carbonate were weighed at a mole ratio of Li:Ni:Mn=1.2:0.2:0.6, followed by pulverization and mixing using a planetary ball mill. The thus obtained powder mixture was baked at 700° C. for 12 hours in an air atmosphere to synthesize a Li-rich material (Li_{1.2}Ni_{0.2}Mn_{0.6}O₂). The average particle size of the obtained Li-rich material was 50 nm.

(Surface Solid Solution Treatment of the Layered Compound with the Li-Rich Material)

The synthesized layered compound and the Li-rich material were weighed at a weight ratio of 95:5, followed by mixing using a planetary ball mill. The thus obtained powder mixture was baked at 900° C. for 1 hour in an air atmosphere to synthesize an active material in which a solid solution was formed with the Li-rich material on the layered compound surface. In general, when a Li-rich material is heated at 900° C., a Li₂MnO₃-derived peak appears. As a result of X-ray diffraction analysis of the synthesized active material, only the peak of the layered compound was detected, while the Li₂MnO₃-derived peak particular to a Li-rich material was not detected. This confirmed that the layered compound was integrated with the Li-rich material.

### (Determination of Surface Concentration)

The synthesized active material was sliced to analyze the composition of a cross section of the active material by TEM-EDX. Table 1 shows the results.

TABLE 1

| Analysis position | | Mn | Co | Ni | Ni/Mn |
|---|---|---|---|---|---|
| Before solid solution formation | | 75 | 0 | 25 | 0.33 |
| Surface | | 56 | 11.8 | 32.2 | 0.57 |
| Depth from the surface | about 10 nm | 49.9 | 14.1 | 36 | 0.72 |
| | about 15 nm | 39 | 19.2 | 41.8 | 1.07 |
| | about 20 nm | 28.6 | 21.3 | 50.1 | 1.75 |
| | about 50 nm | 28.5 | 20.2 | 51.3 | 1.8 |

| | | | | |
|---|---|---|---|---|
| Inner part | 27.3 | 21.3 | 51.4 | 1.88 |

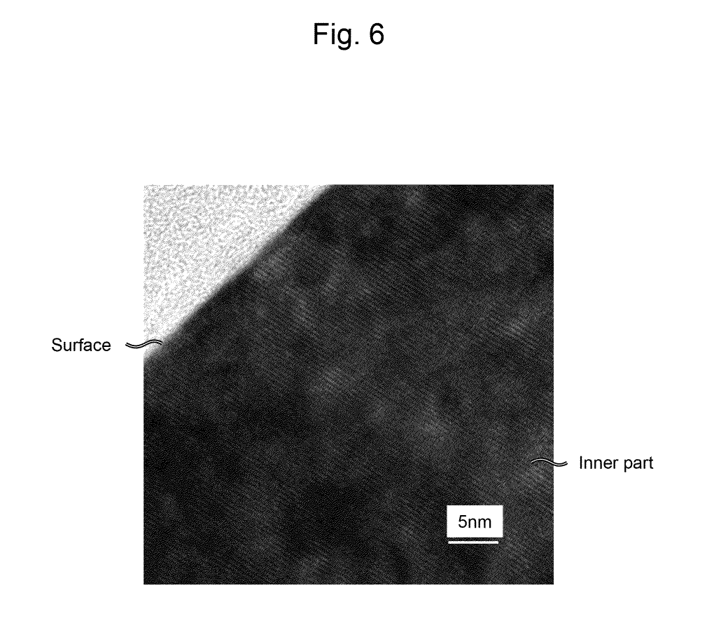

Table 1 indicates that the atomic ratio on the surface of the active material was Ni:Co:Mn=32:12:56, but note that Ni<Mn, because the composition (Ni:Co:Mn=25:0:75) of the Li-rich material was not maintained due to the formation of a solid solution of the Li-rich material and the layered compound. As the depth from the surface increased, the atomic ratio of Ni and Co increased while the atomic ratio of Mn decreased in the transition metal element in an area with a depth of about 20 nm from the surface. In addition, when the depth from the surface was 20 nm or more, an atomic ratio of Ni:Co:Mn=48 to 52:19 to 21:27 to 32 was substantially identical to the composition of the synthesized layered compound NCM523. It is therefore understood that the area up to about 20 nm from the surface corresponds to the surface layer part, and a solid solution layer was formed in the area as a whole. Further, the composition of Mn, Ni, and Co continuously varies in the direction from the surface to the inside, provided that the Ni/Mn atomic ratio in the surface is less than 1. FIG. 6 shows a TEM image of the positive electrode active material. As shown in FIG. 6, uniform layered interference fringes were observed in an area from the active material surface to a depth of 20 nm or more, in which the composition becomes constant, suggesting the formation of a continuous crystal structure.

The Li concentration on the active material surface can be analyzed by electron energy loss spectroscopy (EELS), high-energy X-ray photoelectron spectroscopy (XPS), auger electron spectroscopy, or the like. There is some variation in the atomic ratio, however, Li in the surface layer part was greater than that in the inner part, and it increased or decreased with an increase or decrease in the proportion of Mn.

### Example 2

Example 2 was conducted as in the case of Example 1 except that LiCoO₂ was used as the layered compound. The process of LiCoO₂ synthesis is described below. Lithium carbonate and cobalt carbonate were weighed at a mole ratio of Li:Co=1:1, followed by pulverization and mixing using a planetary ball mill. The thus obtained powder mixture was baked at 950° C. for 12 hours in an air atmosphere to synthesize LiCoO₂.

As a result of X-ray diffraction analysis of the synthesized active material, only the peak of the layered compound was detected, while the Li₂MnO₃-derived peak particular to a Li-rich material was not detected. This confirmed that the layered compound was integrated with the Li-rich material. Ni/Mn mole ratio in the surface layer part was 0.40.

### Example 3

### Synthesis of Layered Compound NCM811 Material

The term “NCM811” used herein refers to a layered compound represented by the composition formula Li₁₊ₓNi_{0.8}Co_{0.1}Mn_{0.1}O_{2+β} (where −0.05<x<0.1 and −0.1<β<0.1).

Lithium carbonate, nickel carbonate, cobalt carbonate, and manganese carbonate were weighed at a mole ratio of Li:Ni:Co:Mn=1.03:0.8:0.1:0.1, followed by pulverization and mixing using a planetary ball mill. The thus obtained powder mixture was baked at 880° C. for 12 hours in an oxygen atmosphere to synthesize a layered active material (Li_{1.03}Ni_{0.8}CO_{0.1}Mn_{0.1}O₂).

### Synthesis of Li-Rich Material (Li_{1.33}Mn_{0.67}O₂)

Lithium carbonate and manganese carbonate were weighed at a mole ratio of Li:Mn=1.33:0.67, followed by pulverization and mixing using a planetary ball mill. The thus obtained powder mixture was baked at 700° C. for 12 hours in an air atmosphere to synthesize a Li-rich material (Li_{1.33}Mn_{0.67}O₂).

(Surface Solid Solution Treatment of the Layered Compound with the Li-Rich Material)

The synthesized layered compound and the Li-rich material were weighed at a weight ratio of 95:5 and pure water was added, followed by mixing using a planetary ball mill. Thus, slurry was prepared. The obtained slurry was spray-dried so that a secondary particle powder mixture of the layered compound and the Li-rich material was obtained. The obtained secondary particle powder mixture was baked at 850° C. for 1 hour in an oxygen atmosphere to synthesize an active material in which a solid solution was formed with the Li-rich material on the layered compound surface. Although the Li-rich material was free of Ni, Ni was diffused from the layered compound to the surface of the synthesized active material. Ni/Mn mole ratio was 0.91 for the surface.

As a result of X-ray diffraction analysis of the synthesized active material, only the peak of the layered compound was detected, while the Li₂MnO₃-derived peak particular to a Li-rich material was not detected. This confirmed that the layered compound was integrated with the Li-rich material.

### Example 4

### Synthesis of Layered Compound NCM811 Material

Lithium carbonate, nickel carbonate, cobalt carbonate, and manganese carbonate were weighed at a mole ratio of Li:Ni:Co:Mn=1.03:0.8:0.1:0.1 and pure water was added, followed by pulverization and mixing using a planetary ball mill. Thus, slurry was prepared. The obtained slurry was spray-dried so that a starting material powder mixture in the form of secondary particles was obtained. The obtained powder mixture was baked at 880° C. for 12 hours in an oxygen atmosphere to synthesize layered active material (Li_{1.03}Ni_{0.8}Co_{0.1}Mn_{0.1}O₂) in the form of secondary particles.

(Surface Solid Solution Treatment of the Layered Compound with the Li-Rich Material)

The synthesized layered compound and the Li-rich material obtained as in the case of Example 3 were weighed at a ratio of 95:5. The layered compound in the form of secondary particles was coated with the Li-rich material by mechanical coating treatment.

The obtained powder was baked at 850° C. for 1 hour in an oxygen atmosphere to synthesize an active material in which a solid solution was formed with the Li-rich material on the secondary particle surface of the layered compound. Although the Li-rich material was free of Ni, Ni was diffused from the layered compound to the surface of the synthesized active material. Ni/Mn mole ratio on the surface was 0.87.

As a result of X-ray diffraction analysis of the synthesized active material, only the peak of the layered compound was detected, while the Li₂MnO₃-derived peak was not detected. This confirmed that the layered compound was integrated with the Li-rich material.

### Comparative Example 1

Comparative Example 1 was conducted as in the case of Example 1 except that surface solid solution treatment of the layered compound (NCM523) with the Li-rich material was not conducted.

### Comparative Example 2

Comparative Example 2 was conducted as in the case of Example 2 except that surface solid solution treatment of the layered compound (LiCoO₂) with the Li-rich material was not conducted.

### Comparative Example 3

Comparative Example 3 was conducted as in the case of Example 3 except that surface solid solution treatment of the layered compound NCM811 material with the Li-rich material was not conducted.

### Comparative Example 4

Comparative Example 4 was conducted as in the case of Example 1 except that layered compound NCM111 material was used as an outer material to form a solid solution on the layered compound NCM523. The process of synthesis of the layered compound NCM111 is described below. Lithium carbonate, nickel carbonate, cobalt carbonate, and manganese carbonate were weighed at a mole ratio of Li:Ni:Co:Mn=1.03:0.333:0.333:0.333, followed by pulverization and mixing using a planetary ball mill. The obtained powder mixture was baked at 700° C. for 12 hours in an air atmosphere.

### Comparative Example 5

An inner material was prepared in accordance with the average composition of Example 3. Lithium carbonate, nickel carbonate, cobalt carbonate, and manganese carbonate were weighed at a mole ratio of Li:Ni:Co:Mn=1.06:0.728:0.091:0.151, followed by pulverization and mixing using a planetary ball mill. The obtained powder mixture was baked at 880° C. for 12 hours in an oxygen atmosphere to synthesize layered active material (Li_{1.06}Ni_{0.728}CO_{0.091}Mn_{0.151}O₂).

### (Evaluation of a Lithium Ion Secondary Battery)

### (Production of a Positive Electrode)

Each of the positive electrode active materials synthesized in Examples 1 to 4 and Comparative Examples 1 to 5, a carbon-based electrical conducting material, and a binder dissolved in advance in N-methyl-2-pyrrolidone (NMP) were mixed at a ratio of 85:10:5 (% by mass). The uniformly mixed slurry was applied over a current collecting material of aluminum foil 20 μm in thickness, dried at 120° C., and subjected to compression molding with a press to achieve an electrode density of 2.5 g/cm³.

### (Production of a Lithium Ion Secondary Battery)

Next, the production of a lithium ion secondary battery is described.

Each manufactured positive electrode was punched into a disc 15 mm in diameter and used. Lithium metal was used for a negative electrode. As a separator, an ion-conductive and insulating porous PP (polypropylene) separator of 30 μm in thickness was used. The electrolytic solution (electrolyte) used herein was a mixture of ethylene carbonate (EC) and dimethyl carbonate (DMC) serving as non-aqueous organic solvents mixed at a volume ratio of 3:7, in which lithium hexafluorophosphate (LiPF₆) was dissolved at a concentration of 1 mol/L. In addition, a lithium metal was used as a reference electrode to determine positive electrode potential.

### (Determination of Rate Characteristics)

Lithium ion secondary batteries prepared using the positive electrode active materials of Examples 1 to 4 and Comparative Examples 1 to 5 were charged at 0.2 C via constant-current/constant-potential charging and then discharged at a constant current of 0.2 C to 3.3 V for determination of discharge capacity. Thereafter, the batteries were charged again at 0.2 C via constant current/constant-potential charging and then discharged at a constant current of 1 C to 3.3V for determination of discharge capacity. The charge upper limit potential was set to 4.6 V in Examples 1 and 3 and Comparative Examples 1, 3 to 5. The charge upper limit potential was set to 4.45V in Example 2 and Comparative Example 2. In addition, the 1 C charge and discharge rate was defined as 210 A/kg on the basis of positive electrode active material weight.

In addition, 1 C discharge capacity and 1 C discharge capacity/0.2 C discharge capacity (hereinafter defined as “rate capacity percentage”) were designated as standards for rate characteristics.

### (Determination of Cycle Characteristics)

Lithium ion secondary batteries comprising the positive electrode active materials of Examples 1 to 4 and Comparative Examples 1 to 5 were charged via 1 C constant-current/constant-potential charging after determination of rate characteristics and discharged at a constant current of 1 C to 3.3 V, which was repeated for 50 cycles. The charge potential was set to the potential for determination of rate characteristics. Discharge capacity at the 50th cycle/discharge capacity at the 1st cycle (hereinafter defined as “cycle capacity percentage”) for determination of cycle characteristics was designated as a standard for cycle characteristics.

Table 2 below shows the 1 C discharge capacities, rate capacity percentages, and cycle capacity percentages for Examples 1 to 4 and Comparative Examples 1 to 5.

TABLE 2

| | | | Surface | 1 C discharge | Rate capacity | Cycle capacity |
|---|---|---|---|---|---|---|
| | Inner material | Outer material | Ni/Mn ratio | capacity | percentage | percentage |
| Example 1 | NCM523 | Li_{1.2}Ni_{0.2}Mn_{0.6}O₂ | 0.57 | 177 Ah/kg | 92.3% | 79.5% |
| Comparative | NCM523 | | 1.60 | 170 Ah/kg | 93.0% | 58.6% |
| Example 1 | | | | | | |
| Comparative | NCM523 | NCM111 | 1.35 | 169 Ah/kg | 93.1% | 60.5% |
| Example 4 | | | | | | |
| Example 2 | LiCoO₂ | Li_{1.2}Ni_{0.2}Mn_{0.6}O₂ | 0.40 | 174 Ah/kg | 98.3% | 68.9% |
| Comparative | LiCoO₂ | | — | 175 Ah/kg | 98.5% | 2.5% |
| Example 2 | | | | | | |
| Example 3 | NCM811 | Li_{1.33}Mn_{0.67}O₂ | 0.91 | 196 Ah/kg | 93.5% | 83.2% |
| Example 4 | NCM811 | Li_{1.33}Mn_{0.67}O₂ | 0.87 | 197 Ah/kg | 93.6% | 81.9% |
| | (Secondary | (Outer part | | | | |
| | particle | consisting of | | | | |
| | formation) | primary particles) | | | | |

| Comparative | NCM811 | 8.0 | 200 Ah/kg | 93.8% | 70.2% |
|---|---|---|---|---|---|
| Example 3 | | | | | |
| Comparative | Li_{1.06}Ni_{0.728}Co_{0.091}Mn_{0.151}O₂ | 4.8 | 185 Ah/kg | 93.7% | 72.0% |
| Example 5 | | | | | |

As a result of comparison between Example 1 and Comparative Examples 1 and 4, between Example 2 and Comparative Example 2, and between Examples 3 and 4 and Comparative Examples 3 and 5, it was found that the cycle capacity percentage was significantly improved while the 1 C discharge capacity and rate capacity percentage were maintained in Examples 1 to 4, in which Ni/Mn mole ratio was less than 1. Although Ni/Mn in Comparative Example 4 was lower than that in Comparative Example 1, Ni/Mn mole ratio was >1. In addition, the surface was formed with the layered compound but not the Li-rich material. Therefore, cycle characteristics substantially did not improve at high potentials.

In Example 4, only primary particles in the outer portion of a secondary particle were allowed to have a concentration difference between the surface layer part and the core part. Nevertheless, the effect of improving cycle capacity percentage was obtained, compared with Comparative Example 3. Note that the effect obtained in Example 3, in which primary particles having a concentration difference between the surface layer part and the core part were used up to the inner part of a secondary particle, was greater than the effect obtained in Example 4. As a result of comparison of Example 3 and Comparative Example 5, the capacity was high and the cycle capacity percentage showed significant improvement in Example 3 over Example 5, although the average composition was the same therebetween.

### LIST OF REFERENCE SIGNS

1: Layered compound
2: Outer material
3: Transition metal M
4: Lithium
5: Oxygen atom
6: Metal oxide
7: Excessive amount of lithium atom
16: Battery module
17: Motor
30: Electric automobile
S: Power generation system

All publications, patents, and patent applications cited herein are incorporated herein by reference in their entirety.

1. A positive electrode active material for lithium ion secondary batteries, comprising particles each having:
a core part comprising a lithium metal composite oxide; and
a surface layer part comprising a lithium metal composite oxide having a composition differing from that in the core part, the surface layer part being formed on the surface of the core part,
wherein both the core part and the surface layer part have a layered structure,
the surface layer part containing Ni, Mn, and Li,
Ni/Mn mole ratio in the surface of the surface layer part being less than 0.95, and
the surface of the surface layer part being represented by the composition formula Li₁₊ₐNi_{b}Mn_{c}A_{d}O_{2+α} (where A is an element other than Li, Ni, and Mn, 0.05≦a<0.33, 0<b<0.45, 0.30≦c<0.75, b/c<1, 0≦d<0.3, a+b+c+d=1, and −0.1<α<0.1).

2. (canceled)

3. The positive electrode active material for lithium ion secondary batteries according to claim 1, wherein the surface layer part has a thickness of 120 nm or less.

4. The positive electrode active material for lithium ion secondary batteries according to claim 1, wherein the core part comprises a compound represented by the composition formula Li₁₊ₓMO_{2+β} (where M is a metal element containing at least Ni or Co, −0.05<x<0.1, and −0.1<β<0.1).

5. The positive electrode active material for lithium ion secondary batteries according to claim 1, wherein the core part contains at least Ni and Mn, and Ni/Mn mole ratio is 1 or more.

6. The positive electrode active material for lithium ion secondary batteries according to claim 5, wherein Ni/Mn mole ratio continuously varies from the surface layer part side to the core part side in an area including at least an interface region between the core part and the surface layer part.

7. The positive electrode active material for lithium ion secondary batteries according to claim 1, wherein the core part contains Co and the mole fraction of Co in the surface layer part is less than the mole fraction of Co in the core part.

8. The positive electrode active material for lithium ion secondary batteries according to claim 7, wherein the mole fraction of Co continuously varies from the core part side to the surface layer part side in an area including at least an interface region between the core part and the surface layer part.

9. The positive electrode active material for lithium ion secondary batteries according to claim 1, wherein the mole fraction of Li in metal elements of the surface layer part is greater than the mole fraction of Li in metal elements of the core part.

10. The positive electrode active material for lithium ion secondary batteries according to claim 9, wherein the mole fraction of Li continuously varies from the core part side to the surface layer part side in an area including at least an interface region between the core part and the surface layer part.

11. The positive electrode active material for lithium ion secondary batteries according to claim 1, wherein a continuous crystal structure is formed between the core part and the surface layer part.

12. The positive electrode active material for lithium ion secondary batteries according to claim 1, which are secondary particles, wherein a plurality of said particles, as primary particles, are aggregated and bound.

13. The positive electrode active material for lithium ion secondary batteries according to claim 1, which are secondary particles, wherein a plurality of said particles and particles of a different lithium metal composite oxide are aggregated and bound, and said particles are contained in at least the surface layer part of each secondary particle.

14. The positive electrode active material for lithium ion secondary batteries according to claim 1, wherein the core part comprises secondary particles each comprising aggregated primary particles.

15. A method for producing a positive electrode active material for lithium ion secondary batteries, comprising:
obtaining a mixture by mixing inner material particles represented by the composition formula Li₁₊ₓMO_{2+β} (where M is a metal element containing at least Ni or Co, −0.05<x<0.1, and −0.1<β<0.1) and outer material particles that are finer than the inner material particles; and
heating the mixture,
wherein the outer material particles are a compound represented by the composition formula Li₁₊ₐNi_{b}Mn_{c}A_{d}O_{2+α} (where A is an element other than Li, Ni, and Mn, 0.05≦a<0.33, 0<b<0.40, 0.35≦c<0.80, b/c<1, 0≦d<0.3, a+b+c+d=1, and −0.1<α<0.1) or a compound represented by the composition formula Li₁₊ₓMn₁₋ₓO_{2+β} (where 0.25<x<0.4 and −0.1<β<0.1).

16. A method for producing a positive electrode active material for lithium ion secondary batteries, comprising:
obtaining a mixture by mixing inner material particles represented by the composition formula Li₁₊ₓMO_{2+β} (where M is a metal element containing at least Ni or Co, −0.05<x<0.1, and −0.1<β<0.1) and outer material particles that are finer than the inner material particles;
heating the mixture to produce primary particles; and
forming secondary particles with the obtained primary particles,
wherein the outer material particles are a compound represented by the composition formula Li₁₊ₐNi_{b}Mn_{c}A_{d}O_{2+α} (where A is an element other than Li, Ni, and Mn, 0.05≦a<0.33, 0<b<0.40, 0.35≦c<0.80, b/c<1, 0≦d<0.3, a+b+c+d=1, and −0.1<α<0.1) or a compound represented by the composition formula Li₁₊ₓMn₁₋ₓO_{2+β} (where 0.25<x<0.4 and −0.1<β<0.1).

17. The method for producing a positive electrode active material for lithium ion secondary batteries according to claim 15, further comprising forming secondary particles with the inner material particles.

18. (canceled)

19. The method for producing a positive electrode active material for lithium ion secondary batteries according to claim 15, wherein said mixing further includes forming a slurry of the mixture by adding liquid, wherein the slurry is spray-dried prior to the step of heating the mixture.

20. The method for producing a positive electrode active material for lithium ion secondary batteries according to claim 15, wherein said heating comprises heating the mixture to 600° C. or more.

21. The method for producing a positive electrode active material for lithium ion secondary batteries according to claim 15, wherein said heating comprises heating the mixture at or below the synthesis temperature of the inner material particles.

22. A lithium ion secondary battery, comprising the positive electrode active material according to claim 1.
